(19) United States
(12) Patent Application Publication
(10) Pub. No.: US 2026/0245166 A1
(43) Pub. Date: Aug. 20, 2026

(54) TARGET ROUND-TRIP TIME-BASED DE-JITTER BUFFER FOR SPLIT EXTENDED REALITY

(71) Applicant: QUALCOMM Incorporated, San Diego, CA (US)

(72) Inventors: Sriram AJAYKUMAR, Bangalore (IN); Vinay MELKOTE KRISHNAPRASAD, Bangalore (IN)

(21) Appl. No.: 19/470,661

(22) PCT Filed: Sep. 14, 2023
(86) PCT No.: PCT/US2023/032789

§ 371 Date: Sep. 29, 2025

(30) Foreign Application Priority Data
May 2, 2023 (IN) 202341031224

(51) Int. Cl. G06T 1/20

(52) U.S. Cl. CPC G06T 1/20; G06T 2200/16

(57) ABSTRACT

This disclosure provides systems, devices, apparatus, and methods, including computer programs encoded on storage media, for a target round-trip time-based de-jitter buffer for split extended reality. A processor may obtain a frame that is associated with a split rendering process between a server and a client device. The processor may calculate a wait time for data associated with the frame based on a target round-trip time (TRTT) of the frame, where the TRTT is a target time the data associated with the frame takes to travel between the client device and the server and back to the client device. The processor may output the frame upon an expiration of the wait time.

### CROSS REFERENCE TO RELATED APPLICATION(S)

This application claims the benefit of Indian Provisional Application No. 202341031224, entitled “TARGET ROUND-TRIP TIME-BASED DE-JITTER BUFFER FOR SPLIT EXTENDED REALITY” and filed on May 2, 2023, which is expressly incorporated by reference herein in its entirety.

### TECHNICAL FIELD

The present disclosure relates generally to processing systems, and more particularly, to one or more techniques for display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for split rendering may not address jitter associated with round-trip time (RTT) latency. There is a need for improved techniques for reducing jitter.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and a processor coupled to the memory and, based on information stored in the memory, the processor is configured to: obtain a frame that is associated with a split rendering process between a server and a client device; calculate a wait time for data associated with the frame based on a target round-trip time (TRTT) of the frame, where the TRTT is a target time the data associated with the frame takes to travel between the client device and the server and back to the client device; and output the frame upon an expiration of the wait time.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example display framework including a display processor and a display in accordance with one or more techniques of this disclosure.

FIG. 4 is a diagram illustrating an example of a split extended reality (XR) system in accordance with one or more techniques of this disclosure.

FIG. 5 is a diagram illustrating an example of overlapping networks in accordance with one or more techniques of this disclosure.

FIG. 6 is a diagram illustrating an example of a server and a client head mounted display (HMD) in accordance with one or more techniques of this disclosure.

FIG. 7 is a diagram illustrating an example of a server and a client HMD with a de-jitter buffer in accordance with one or more techniques of this disclosure.

FIG. 8 is a diagram illustrating a first example of a de-jitter buffer in a client HMD in accordance with one or more techniques of this disclosure.

FIG. 9 is a diagram illustrating a second example of a de-jitter buffer in a client HMD in accordance with one or more techniques of this disclosure.

FIG. 10 is a call flow diagram illustrating example communications between a client device and a server in accordance with one or more techniques of this disclosure.

FIG. 11 is a flowchart of an example method of display processing in accordance with one or more techniques of this disclosure.

FIG. 12 is a flowchart of an example method of display processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

Split rendering (i.e., a split rendering process) may refer to a paradigm whereby a client device (e.g., an HMD) and a server collaborate to facilitate the display of graphical content on a display of the client device, where the client device and the server may be in wired communication and/or in wireless communication with one another. For instance, a portion of rendering tasks (or other tasks) may be offloaded to the server. The server may perform the rendering tasks (or the other tasks). The server may transmit an output of the rendering tasks (or the other tasks) to the client device. The client device may perform additional processing based on the received output in order to display the graphical content. Split rendering (e.g., split XR rendering) may enable the client device to present relatively high quality graphical content on a display while conserving battery life of the client device.

When there is heavy interference between a server and a client device (e.g., interference from other networks), there may be a relatively high amount of jitter associated with a round-trip latency between the client device and the server. Jitter may refer to a deviation from a true periodicity of a presumably periodic signal. The round-trip latency may correspond to a time period that data takes to travel from the client device to the server and back to the client device. For instance, the relatively high amount of jitter may be from a streaming latency (i.e., network latency). When there is jitter associated with a streaming latency, latest rendered frames may frequently not be available for display. As such, the client device may reproject a previously rendered frame (a frame repeat) when a latest rendered frame is not available for display. Frame repeats may impact a user experience with the client device.

Various technologies pertaining to a target round-trip time-based de-jitter buffer for split extended reality are described herein. In an example, an apparatus (e.g., a client device) obtains a frame that is associated with a split rendering process between a server and a client device. The apparatus calculates a wait time for the frame based on a target round-trip time (TRTT) of data associated with the frame, where the TRTT is a target time the data associated with the frame takes to travel between the client device and the server and back to the client device. The apparatus outputs the frame upon an expiration of the wait time. Vis-à-vis calculating the wait time for the data associated with the frame and outputting the frame upon an expiration of the wait time, the apparatus may cause frames to incur a fixed round-trip latency before the frames are input to a decoder, which may reduce jitter. Furthermore, as the TRTT may be increased depending on channel interference conditions, the above-described technologies may lead to lower packet error rates associated with frames.

A user may wear a display device in order to experienced extended reality (XR) content. XR may refer to a technology that blends aspects of a digital experience and the real world (i.e., XR content). XR may include augmented reality (AR), mixed reality (MR), and/or virtual reality (VR). In AR, AR objects may be superimposed on a real-world environment as perceived through the display device. In an example, AR content may be experienced through AR glasses that include a transparent or semi-transparent surface. An AR object may be projected onto the transparent or semi-transparent surface of the glasses as a user views an environment through the glasses. In general, the AR object may not be present in the real world and the user may not interact with the AR object. In MR, MR objects may be superimposed on a real-world environment as perceived through the display device and the user may interact with the MR objects. In some aspects, MR objects may include “video see through” with virtual content added. In an example, the user may “touch” a MR object being displayed to the user (i.e., the user may place a hand at a location in the real world where the MR object appears to be located from the perspective of the user), and the MR object may “move” based on the MR object being touched (i.e., a location of the MR object on a display may change). In general, MR content may be experienced through MR glasses (similar to AR glasses) worn by the user or through a head mounted display (HMD) worn by the user. The HMD may include a camera and one or more display panels. The HMD may capture an image of environment as perceived through the camera and display the image of the environment to the user with MR objects overlaid thereon. Unlike the transparent or semi-transparent surface of the AR/MR glasses, the one or more display panels of the HMD may not be transparent or semi-transparent. In VR, a user may experience a fully-immersive digital environment in which the real-world is blocked out. VR content may be experienced through an HMD. An XR device may refer to a device that is capable of presenting XR content.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

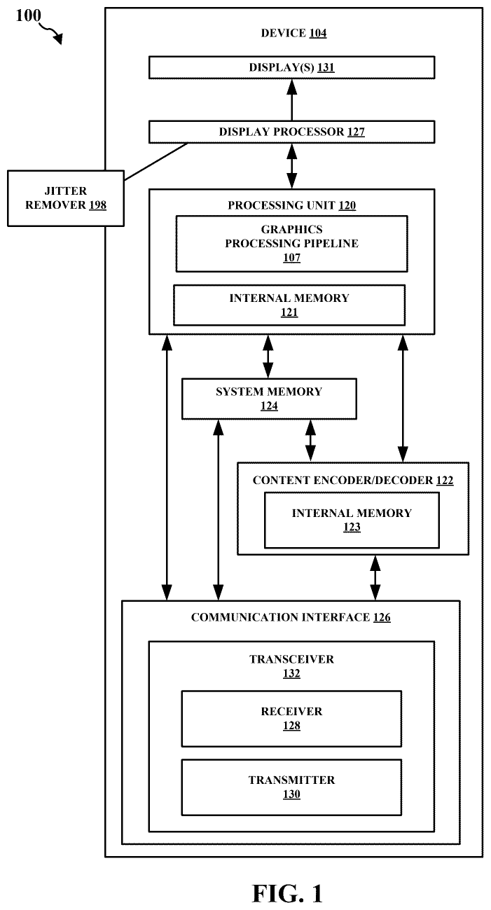

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123.

In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the display processor 127 may include a jitter remover 198 configured to obtain a frame that is associated with a split rendering process between a server and a client device; calculate a wait time for data associated with the frame based on a target round-trip time (TRTT) of the frame, where the TRTT is a target time the data associated with the frame takes to travel between the client device and the server and back to the client device; and output the frame upon an expiration of the wait time. Although the following description may be focused on display processing, the concepts described herein may be applicable to other similar processing techniques. Furthermore, although the following description may be focused on split XR rendering, the concepts described herein may be applicable to split rendering in general.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

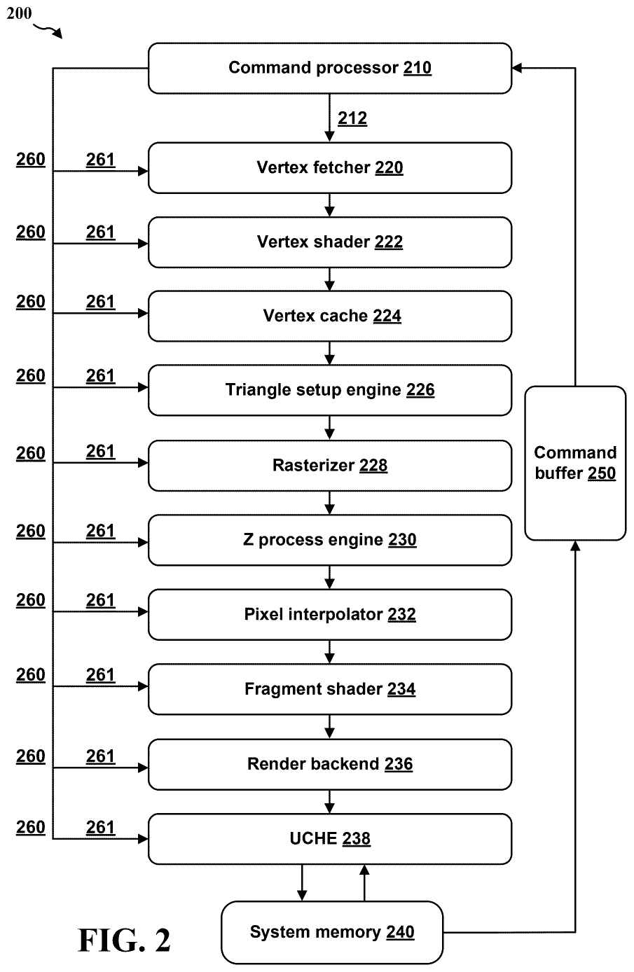

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering). In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

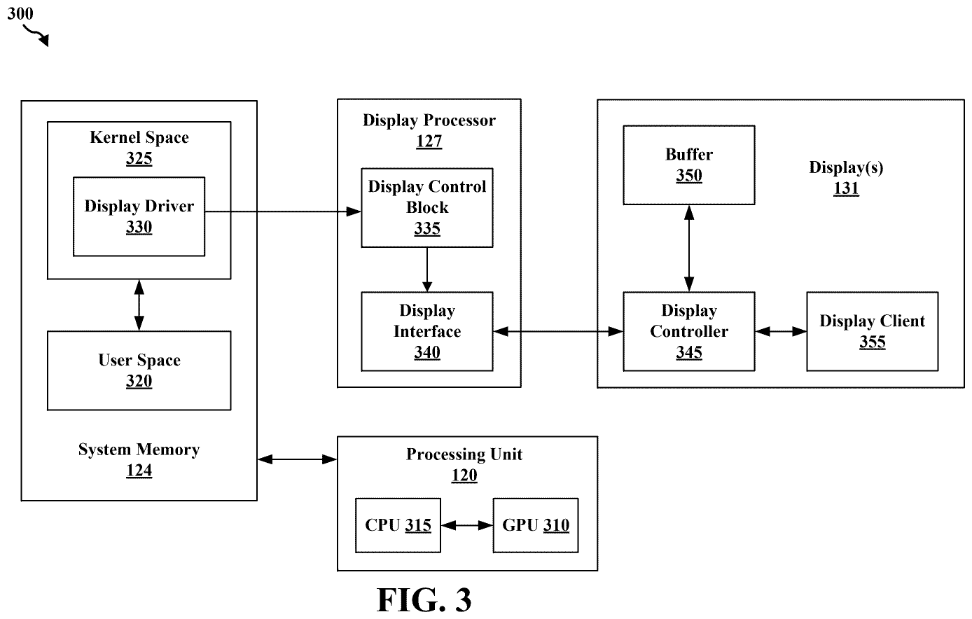

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

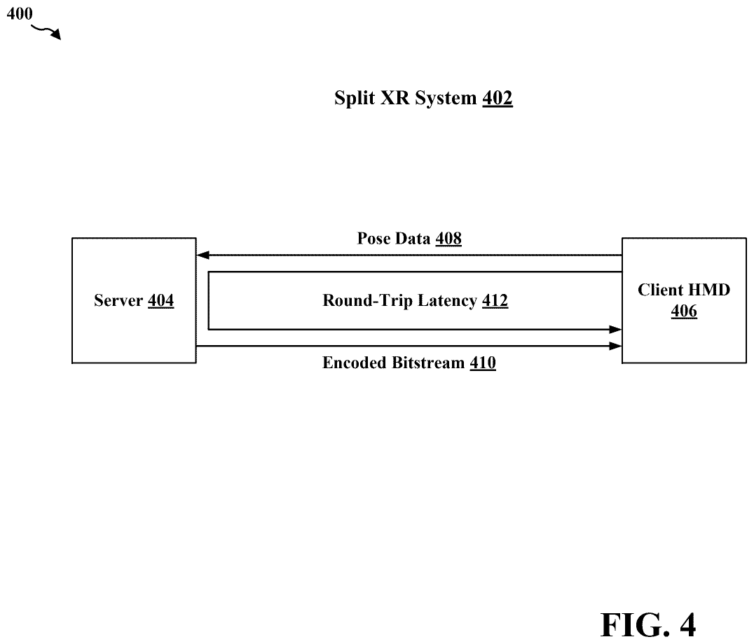

FIG. 4 is a diagram 400 illustrating an example of a split extended reality (XR) system 402 in accordance with one or more techniques of this disclosure. As used herein, split XR may refer to a paradigm whereby a client device (e.g., an HMD) and a remote device (e.g., a server) collaborate to facilitate the display of graphical content on a display of the client device, where the client device and the remote device may be in wired communication and/or in wireless communication with one another. For instance, a portion of rendering tasks (or other tasks) may be offloaded to the server. The server may perform the rendering tasks (or the other tasks). The server may transmit an output of the rendering tasks (or the other tasks) to the client device. The client device may perform additional processing based on the received output in order to display the graphical content. Split XR may enable the client device to present relatively high quality graphical content on a display while conserving battery life of the client device.

The split XR system 402 may include a server 404 and a client HMD 406. The server 404 may also be referred to as a companion device, a remote device, etc. In an example, the server 404 may be a cloud server, a desktop computing device (i.e., a personal computer (PC)), a server computing device, a gaming console, or a phone. In an example, the server 404 may be or include the device 104. The client HMD 406 may also be referred to as XR glasses, a client device, a client, an HMD, a wearable display device, etc. In an example, the client HMD 406 may be the device 104. In an example, the client HMD 406 may be worn over/around/near one or more eyes of a user. For instance, the client HMD 406 may include display(s) that are located several centimeters from one or more eyes of the user when the user wears the client HMD 406. The client HMD 406 may be capable of presenting XR content to the user. The server 404 and the client HMD 406 may be in wired communication with one another and/or the server 404 and the client HMD 406 may be in wireless communication with one another. In an example, the server 404 and the client HMD 406 may be in communication with one another via a wireless local area network (WLAN) link, a cellular link (e.g., 5G New Radio (NR)), and/or a Bluetooth™ link (Bluetooth is a trademark of the Bluetooth Special Interest Group (SIG).

The server 404 may have relatively greater computational capabilities compared to computational capabilities of the client HMD 406. For instance, the server 404 may have a faster processor and/or a greater amount of memory in comparison to a processor and/or memory of the client HMD 406. Furthermore, the client HMD 406 may have a limited battery capacity, whereas the server 404 may not have a limited battery capacity.

In the split XR system 402, the client HMD 406 may transmit pose data 408 (i.e., HMD pose data) to the server 404, where the pose data 408 is for the client HMD 406. The pose data 408 may be a six-degrees of freedom (6DOF) pose that includes location information (e.g., an x-coordinate, a y-coordinate, and a z-coordinate) and orientation information (e.g., a roll, a pitch, and a yaw) of the client HMD 406. The client HMD 406 may also transmit other data to the server 404, such as state information of an application executing on the client HMD 406.

The server 404 may render XR content based on the pose data 408. The server 404 may also render the XR content additionally based on the other data transmitted to the server 404. The server 404 may compress the rendered XR content and transmit the rendered XR content to the client HMD 406 in an encoded bitstream 410.

Furthermore, the server 404 may extrapolate a render pose based on the pose data 408 and the encoded bitstream 410 may also include an indication of the render pose. The client HMD 406 may receive and decompress the encoded bitstream 410 to obtain the rendered XR content. The client HMD 406 may warp the rendered XR content based on the render pose and a latest display pose of the client HMD 406. The client HMD 406 may perform additional rendering on the rendered XR content in order to present the rendered XR content on a display of the client HMD 406. The pose data 408 and the encoded bitstream 410 may be associated with a round-trip latency 412. The round-trip latency 412 may be a total time that elapses from a time at which the pose data 408 is transmitted to the server 404 to a time at which the encoded bitstream 410 is received at the client HMD 406.

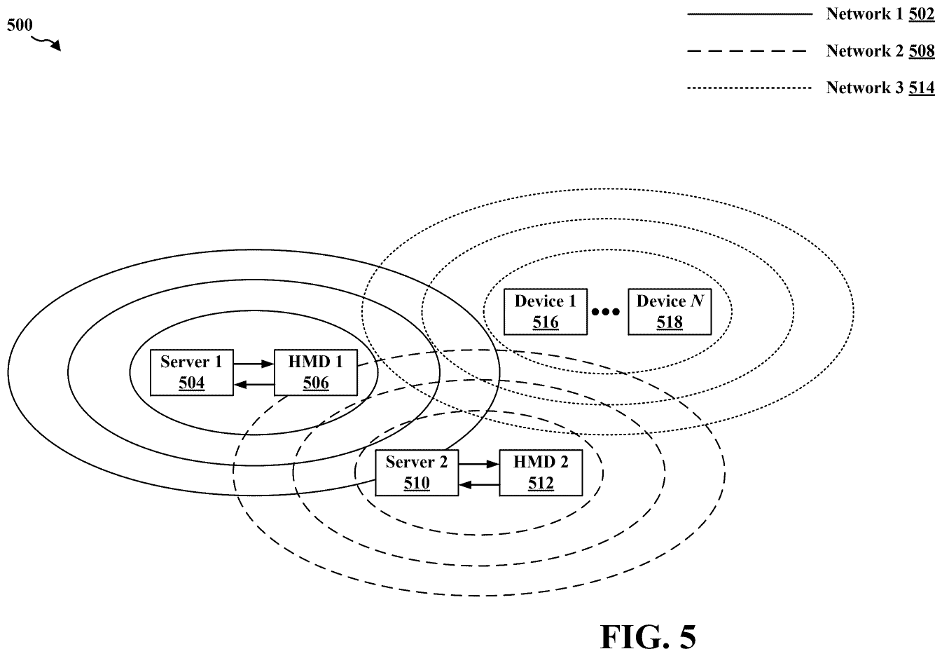

FIG. 5 is a diagram 500 illustrating an example of overlapping networks in accordance with one or more techniques of this disclosure. Different networks in the same geographical area may have overlapping communication channels. In an example, a first network 502 may include a first server 504 and a first HMD 506, where the first server 504 and the first HMD 506 may be part of a first split XR system (e.g., the split XR system 402). The first server 504 and the first HMD 506 may communicate over a first wireless connection. In the diagram 500, a signal strength of the first network 502 is represented by concentric ovals. A signal strength of the first network 502 may be strongest at the inner oval of the first network 502 and the signal strength of the first network 502 may be lowest at an outer oval of the first network 502. A second network 508 may include a second server 510 and a second HMD 512, where the second server 510 and the second HMD 512 may be part of a second split XR system. The second server 510 and the second HMD 512 may communicate over a second wireless connection. In the diagram 500, a signal strength of the second network 508 is represented by concentric ovals. A signal strength of the second network 508 may be strongest at the inner oval of the second network 508 and the signal strength of the second network 508 may be lowest at an outer oval of the second network 508. A third network 514 may include a first device 516 and an Nth device 518, where Nis a positive integer greater than one. The first device 516 and the Nth device 518 may communicate over wireless connection(s). In the diagram 500, a signal strength of the third network 514 is represented by concentric ovals. A signal strength of the third network 514 may be strongest at the inner oval of the third network 514 and the signal strength of the third network 514 may be lowest at an outer oval of the third network 514.

The first network 502, the second network 508, and/or the third network 514 may experience interference from one another. The interference may impact communication reliability in the first network 502, the second network 508, and/or the third network 514. For instance, the interference may cause jitter with respect to frames transmitted via the first network 502. With more particularity, the jitter may affect a round-trip latency between the first server 504 and the first HMD 506. Jitter may refer to a deviation from a true periodicity of a presumably periodic signal. Jitter may cause a latest rendered frame to not be available for display. When a latest rendered frame is not available for display, a device (e.g., the first HMD 506) may reproject a previously rendered frame (i.e., repeat a frame), which may impact a user experience. In an example, the first network 502 may experience relatively low interference from the third network 514 due to a signal strength of the third network 514 being relatively low around the first server 504 and the first HMD 506. In another example, the first network 502 may experience relatively high interference from the second network 508 due to a signal strength of the second network 508 being relatively high around the first server 504 and the first HMD 506.

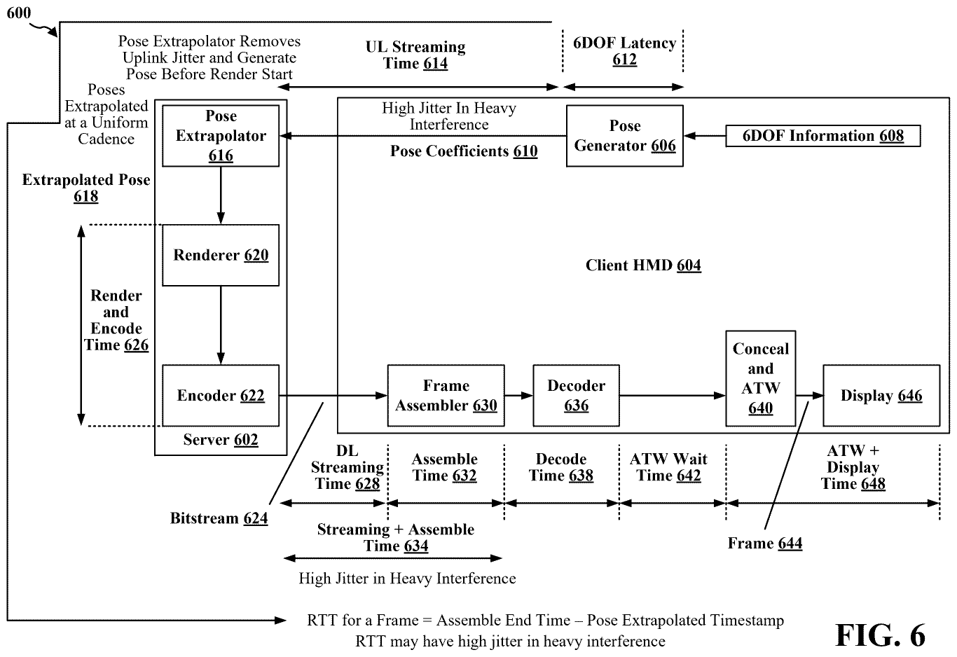

FIG. 6 is a diagram 600 illustrating an example of a server 602 and a client HMD 604 in accordance with one or more techniques of this disclosure. In one example, the server 602 may be the device 104. In another example, the client HMD 604 may be the device 104. In a further example, the server 602 may be the first server 504 and the client HMD 604 may be the first HMD 506. In yet another example, the server 602 may be the server 404 and the client HMD 604 may be the client HMD 406. In an example, the server 602 and the client HMD 604 may be in wireless communication with one another.

The client HMD 604 may include a pose generator 606 (which may also be referred to as a pose and coefficients generator). The pose generator 606 may obtain 6DOF information 608 generated by the client HMD 604. In an example, the 6DOF information 608 may be generated by way of an inertial measurement unit (IMU) of the client HMD 604. The pose generator 606 may generate pose coefficients 610 based on the 6DOF information 608. A time period that the pose generator 606 takes to generate the pose coefficients 610 may be referred to as a 6DOF latency 612. The pose coefficients 610 may include/be associated with a pose generation timestamp, where the pose generation timestamp corresponds to a time instance at which the pose generator 606 generated the pose coefficients 610. The client HMD 604 may transmit the pose coefficients 610 to the server 602. A time period between a time instance at which the pose coefficients 610 are transmitted by the client HMD 604 and a time instance at which the pose coefficients are received at the server 602 may be referred to as an uplink (UL) streaming time 614. In an example, there may be heavy interference between the client HMD 604 and the server 602 which may cause high jitter (i.e., uplink jitter) with respect to the pose coefficients 610.

The server 602 may include a pose extrapolator 616 (which may also be referred to as a server-side pose extrapolator). The pose extrapolator 616 may remove/mitigate uplink jitter associated with the transmission of the pose coefficients 610 and generate an extrapolated pose 618 before a start of rendering of a frame at the server 602. With more particularity, the pose extrapolator 616 may extrapolate based on the pose coefficients in order to generate the extrapolated pose 618. The extrapolated pose 618 may correspond to a predicted pose of the client HMD 604 at a predicted display time of the frame. The extrapolated pose 618 may include/be associated with a pose extrapolated timestamp corresponding to the predicted display time of the frame. In one aspect, the pose extrapolated timestamp may be analogous (i.e., similar or identical) to the pose generation timestamp. The pose extrapolator 616 may extrapolate poses at a uniform cadence.

The server 602 may include a renderer 620. The renderer 620 may render a frame based on the extrapolated pose 618. The renderer 620 may also render the frame additionally based on other information (e.g., application state information) received from the client HMD 604.

The server 602 may include an encoder 622. The encoder 622 may encode the frame rendered by the renderer 620 and the encoder 622 may generate a bitstream 624 that represents the encoded frame. An encoded frame may refer to a frame that has been encoded in order to facilitate the transmission of the frame across a network (e.g., a wireless network). A time period that the server 602 takes to render and encode the frame may be referred to as a render and encode time 626.

The server 602 may transmit the bitstream 624 to the client HMD 604. The client HMD 604 may receive the bitstream 624. A time period between a time instance at which the server 602 transmits the bitstream 624 and a time instance at which the bitstream 624 is received at the client HMD 604 may be referred to as a downlink (DL) streaming time 628.

The client HMD 604 may include a frame assembler 630. The frame assembler 630 may assemble an (encoded) frame based on the bitstream 624 received by the client HMD 604. A time period that the frame assembler 630 takes to assemble the (encoded) frame may be referred to as an assemble time 632. A sum of the DL streaming time 628 and the assemble time 632 may be referred to as a streaming and assemble time 634. In an example, there may be heavy interference between the client HMD 604 and the server 602 which may cause high jitter (i.e., downlink jitter) with respect to the (encoded) frame. The downlink jitter may be associated with the streaming and assemble time 634.

A round-trip time (RTT) associated with the frame (i.e., a frame associated with the pose coefficients 610) may be based on a time instance at which the frame assembler 630 assembled the (encoded) frame and a time instance at which the pose coefficients were generated. The RTT may also be referred to as an actual round-trip time (ARTT). The RTT associated with the frame may have high jitter in heavy channel interference conditions. The RTT of the frame may be provided by equation (I) below.

$$R T T for a frame = Assemble End Time - Pose Extrapolated Timestamp \qquad ( I )$$

The client HMD 604 may include a decoder 636. The decoder 636 may decode the (assembled and encoded) frame. A time period that the decoder 636 takes to decode the (assembled and encoded) frame may be referred to as a decode time 638.

In an example, the bitstream 624 may include/be associated with a plurality of packets corresponding to the frame. However, some packets in the plurality of packets may be lost (i.e., not received by the client HMD 604). At 640, the client HMD 604 may conceal errors associated with the lost packets. Furthermore, at 640, the client HMD 604 may perform an asynchronous timewarp (ATW) on the decoded frame based on a latest available pose of the client HMD 604. The concealment and the ATW performed on the decoded frame may generate a frame 644. ATW may refer to a timewarp that occurs in parallel with rendering. Timewarp may refer to a technique that warps a rendered frame before the rendered frame is sent to a display in order to correct for head movement of the client HMD 604 that occurred after rendering. ATW may “fill in” missed frames and may reduce judder. Judder may refer to a mixture of smearing and strobing that occurs on the client HMD 604. A time period that the client HMD 604 waits to perform the ATW may be referred to as an ATW wait time 642.

Subsequent to performing the concealment and the ATW at 640, the client HMD 604 may transmit the frame 644 to a display 646, where the frame 644 may be displayed on the display 646. A sum of the ATW wait time 642 and a time period that elapses between the completion of the ATW and display of the frame 644 may be referred to as an ATW and display time 648.

As indicated above, when there is heavy interference between a server and a client HMD, there may be a relatively high amount of jitter associated with a round-trip latency between the client HMD and the server. For instance, the relatively high amount of jitter may be from a streaming latency (i.e., network latency). When there is jitter associated with a streaming latency, latest rendered frames may frequently not be available for display. As such, the client HMD may reproject a previously rendered frame (a frame repeat) when a latest rendered frame is not available for display. In an example, 25-30% of display frames may be associated with stale rendered frames under heavy interference channel conditions. The stale rendered frames may be perceived as translational judder. Aspects presented herein may utilize a de-jitter buffer on a client HMD that is configured to absorb jitter associated with an RTT between the client HMD and the server such that frames are played back (i.e., displayed) at a fixed rate that is equal to a render rate.

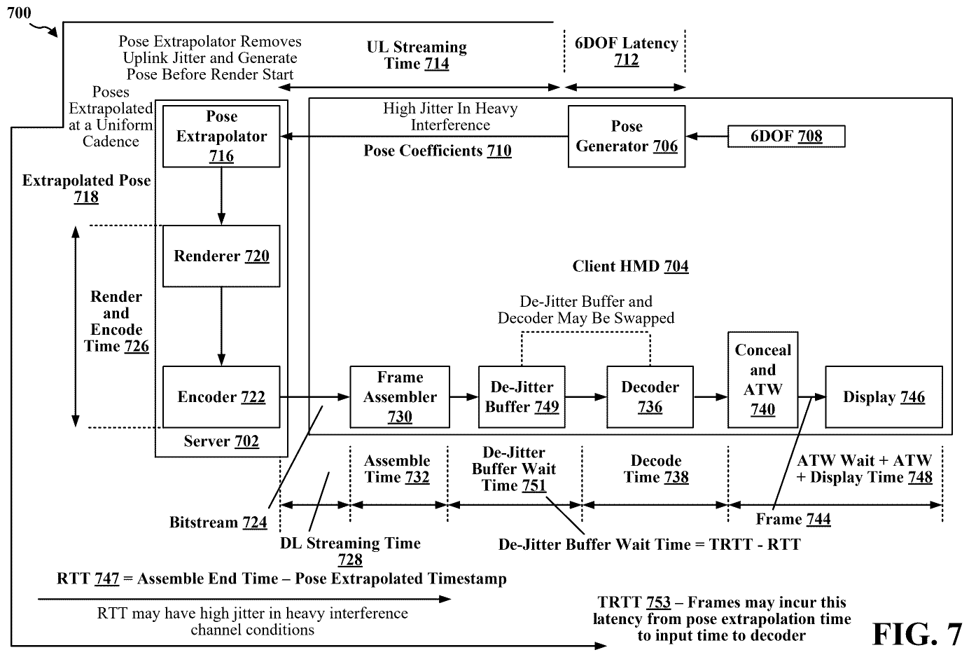

FIG. 7 is a diagram 700 illustrating an example of a server 702 and a client HMD 704 with a de-jitter buffer in accordance with one or more techniques of this disclosure. In one example, the server 702 may be the device 104. In another example, the client HMD 704 may be the device 104. In a further example, the server 702 may be the first server 504 and the client HMD 704 may be the first HMD 506. In yet another example, the server 702 may be the server 404 and the client HMD 704 may be the client HMD 406. In an example, the server 702 and the client HMD 704 may be in wireless communication with one another.

The client HMD 704 may include a pose generator 706 (which may also be referred to as a pose and coefficients generator). The pose generator 706 may obtain six-degrees of freedom (6DOF) information 708 generated by the client HMD 704. In an example, the 6DOF information 708 may be generated by way of an inertial measurement unit (IMU) of the client HMD 704. The pose generator 706 may generate pose coefficients 710 based on the 6DOF information 708. A time period that the pose generator 706 takes to generate the pose coefficients 710 may be referred to as a 6DOF latency 712. The pose coefficients 710 may include/be associated with a pose generation timestamp, where the pose generation timestamp corresponds to a time instance at which the pose generator 706 generated the pose coefficients 710. The client HMD 704 may transmit the pose coefficients 710 to the server 702. A time period between a time instance at which the pose coefficients 710 are transmitted by the client HMD 704 and a time instance at which the pose coefficients are received at the server 702 may be referred to as an uplink (UL) streaming time 714. In an example, there may be heavy interference between the client HMD 704 and the server 702 which may cause high jitter (i.e., uplink jitter) with respect to the pose coefficients 710.

The server 702 may include a pose extrapolator 716 (which may also be referred to as a server-side pose extrapolator). The pose extrapolator 716 may remove/mitigate uplink jitter associated with the transmission of the pose coefficients 710 and generate an extrapolated pose 718 before a start of rendering of a frame at the server 702. With more particularity, the pose extrapolator 716 may extrapolate based on the pose coefficients in order to generate the extrapolated pose 718. The extrapolated pose 718 may correspond to a predicted pose of the client HMD 704 at a predicted display time of the frame. The extrapolated pose 718 may include/be associated with a pose extrapolated timestamp corresponding to the predicted display time of the frame. In one aspect, the pose extrapolated timestamp may be analogous (i.e., similar or identical) to the pose generation timestamp. The pose extrapolator 716 may extrapolate poses at a uniform cadence.

The server 702 may include a renderer 720. The renderer 720 may render a frame based on the extrapolated pose 718. The renderer 720 may also render the frame additionally based on other information (e.g., application state information) received from the client HMD 704.

The server 702 may include an encoder 722. The encoder 722 may encode the frame rendered by the renderer 720 and the encoder 722 may generate a bitstream 724 that represents the encoded frame. A time period that the server 702 takes to render and encode the frame may be referred to as a render and encode time 726.

The server 702 may transmit the bitstream 724 to the client HMD 704. The client HMD 704 may receive the bitstream 724. A time period between a time instance at which the server 702 transmits the bitstream 724 and a time instance at which the bitstream 724 is received at the client HMD 704 may be referred to as a downlink (DL) streaming time 728.

The client HMD 704 may include a frame assembler 730. The frame assembler 730 may assemble an (encoded) frame based on the bitstream 724 received by the client HMD 704. A time period that the frame assembler 730 takes to assemble the (encoded) frame may be referred to as an assemble time 732. A sum of the DL streaming time 728 and the assemble time 732 may be referred to as a streaming and assemble time. In an example, there may be heavy interference between the client HMD 704 and the server 702 which may cause high jitter (i.e., downlink jitter) with respect to the (encoded) frame. The downlink jitter may be associated with the streaming and assemble time.

An RTT 747 associated with the frame (i.e., a frame associated with the pose coefficients 710) may be based on a time instance at which the frame assembler 730 assembled the (encoded) frame and a time instance at which the pose coefficients were generated. The RTT 747 may also be referred to as an actual round-trip time (ARTT). The RTT 747 associated with the frame may have high jitter in heavy channel interference conditions. The RTT 747 may be calculated according to equation (I) above.

The client HMD 704 may include a de-jitter buffer 749. The de-jitter buffer 749 may be a software buffer configured to hold a frame (e.g., an assembled and encoded frame) for a period of time (i.e., a de-jitter buffer wait time 751). The de-jitter buffer wait time 751 may be based on a target round-trip time (TRTT) 753 and the RTT 747. The TRTT 753 may control an amount of jitter associated with the RTT 747 that is to be reduced. With more particularity, the de-jitter buffer 749 may cause frames to incur a latency corresponding to the TRTT from a pose extrapolation time to an input time to a decoder. The TRTT 753 may be preconfigured or the TRTT 753 may be dynamically adjusted/adapted. In one aspect, the de-jitter buffer 749 may be a fixed length de-jitter buffer. In another aspect, the de-jitter buffer 749 may be a fixed TRTT de-jitter buffer. In a further aspect, the de-jitter buffer 749 may be an adaptive length de-jitter buffer. In yet another aspect, the de-jitter buffer 749 may be an adaptive TRTT de-jitter buffer. The de-jitter buffer wait time 751 may also be referred to as a wait time. The de-jitter buffer wait time 751 for a frame may be computed according to equation (II) below.

$$Wait Time = T R T T - R T T \qquad ( II )$$

The client HMD 704 may include a decoder 736. The decoder 736 may decode the (assembled and encoded) frame after the (assembled and encoded) frame is released from the de-jitter buffer 749 upon an expiration of the de-jitter buffer wait time 751. A time period that the decoder 736 takes to decode the (assembled and encoded) frame may be referred to as a decode time 738.

In an example, the bitstream 724 may include/be associated with a plurality of packets corresponding to the frame. However, some packets in the plurality of packets may be lost (i.e., not received by the client HMD 704). At 740, the client HMD 704 may conceal errors associated with the lost packets. Furthermore, at 740, the client HMD 704 may perform an asynchronous timewarp (ATW) on the decoded frame based on a latest available pose of the client HMD 704. The concealment and the ATW performed on the decoded frame may generate a frame 744. ATW may refer to a timewarp that occurs in parallel with rendering. Timewarp may refer to a technique that warps a rendered frame before the rendered frame is sent to a display in order to correct for head movement of the client HMD 704 that occurred after rendering. ATW may “fill in” missed frames and may reduce judder. Judder may refer to a mixture of smearing and strobing that occurs on the client HMD 704. A time period that the client HMD 704 waits to perform the ATW may be referred to as an ATW wait time.

Subsequent to performing the concealment and the ATW at 740, the client HMD 704 may transmit the frame 744 to a display 746, where the frame 744 may be displayed on the display 746. A sum of the ATW wait time, a time to perform the ATW, and a time period that elapses between the completion of the ATW and display of the frame 644 may be referred to as an ATW wait, ATW, and display time 748.

Although the de-jitter buffer 749 is depicted as occurring before the decoder 736 in the diagram 700, other possibilities may be contemplated. In one aspect, the decoder 736 may occur before the de-jitter buffer 749. In such an aspect, the decoder 736 may decode the (encoded) frame assembled by the frame assembler 730. The de-jitter buffer 749 may hold the (decoded and assembled) frame for the de-jitter buffer wait time 751. Upon an expiration of the de-jitter buffer wait time 751, the client HMD 604 may perform the concealment and the ATW at 740.

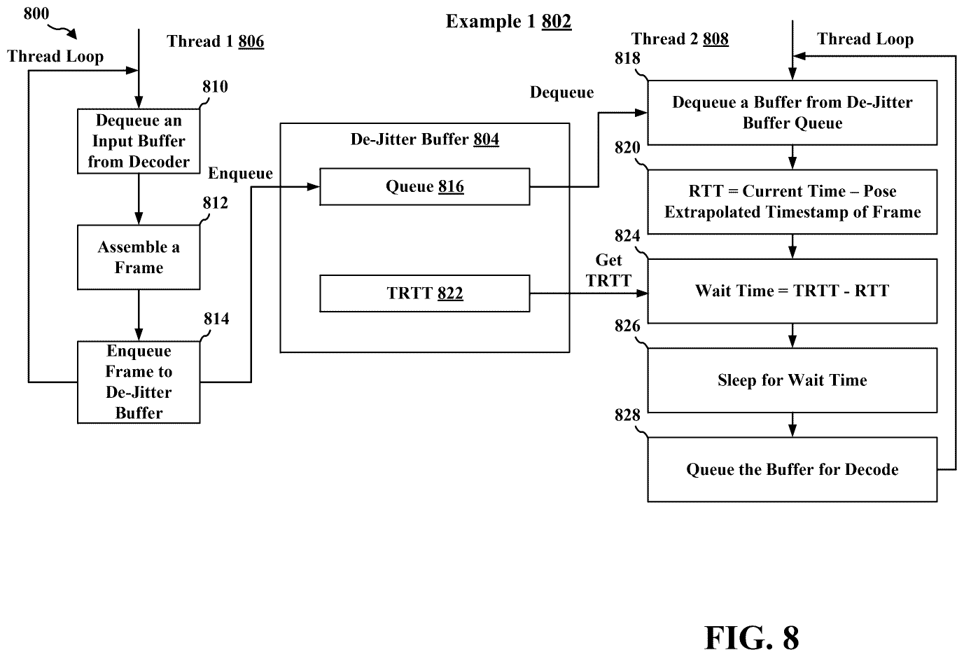

FIG. 8 is a diagram 800 illustrating a first example 802 of a de-jitter buffer 804 in a client HMD in accordance with one or more techniques of this disclosure. In an example, the de-jitter buffer 804 may be or include the de-jitter buffer 749. In an example, the de-jitter buffer 804 may be included in the device 104, the client HMD 406, the first HMD 506, the second HMD 512, or the client HMD 704. The de-jitter buffer 804 may be implemented in software. The de-jitter buffer 904 may be a fixed length de-jitter buffer or a fixed TRTT de-jitter buffer.

The de-jitter buffer 804 may be associated with a first thread 806 (i.e., a first software thread) and a second thread 808 (i.e., a second software thread). The first thread 806 and the second thread 808 may operate concurrently. At 810, the first thread 806 may dequeue an input buffer from a decoder (e.g., the decoder 736). At 812, the first thread 806 may assemble a frame based on the input buffer. At 814, the first thread 806 may enqueue the assembled frame to a queue 816 included in or associated with the de-jitter buffer 804. A queue may refer to first in, first out data structure. The queue 816 may also be referred to as a de-jitter buffer queue. The first thread 806 may perform 810, 812, and 814 in a loop (i.e., a thread loop). As depicted in the diagram 800 and as described above, the first thread 806 may push frames to the queue 816 as frames are assembled.

At 818, the second thread 808 may dequeue a buffer from the queue 816. At 820, the second thread 808 may calculate an RTT. In an example, the second thread 808 may calculate the RTT according to equation (I) above. In another example, the second thread 808 may calculate the RTT as a difference between a current time and a pose extrapolated timestamp of a frame. The pose extrapolated timestamp of the frame may be a time at which pose coefficients were generated by a client HMD or a time at which a pose was extrapolated from the pose coefficients.

The second thread 808 may obtain a TRTT 822 that is included in or associated with the de-jitter buffer 804. The TRTT 822 may be the TRTT 753. The TRTT may control an amount of jitter reduced for an RTT. The de-jitter buffer 804 may help to ensure that frames incur a latency corresponding to the TRTT 822 before a frame is input to a decoder. At 824, the second thread 808 may calculate a wait time according to equation (II) above, that is, the wait time may be a difference between the TRTT 822 and the RTT calculated at 820. At 826, the second thread 808 may sleep for the wait time. At 828, the second thread 808 may queue the buffer (that was dequeued from the queue 816) for decoding. In the event that the wait time computed at 824 is zero or negative, the second thread 808 may skip sleeping at 826 (i.e., the second thread 808 may sleep for zero seconds). The second thread 808 may perform 818, 820, 824, 826, and 828 in a loop (i.e., a thread loop). As depicted in the diagram 800 and as described above, the second thread 808 may pop frames from the queue 816 and calculate a wait time for a frame using a TRTT. After sleeping for the wait time (e.g., several milliseconds), the second thread 808 may input a frame to a decoder.

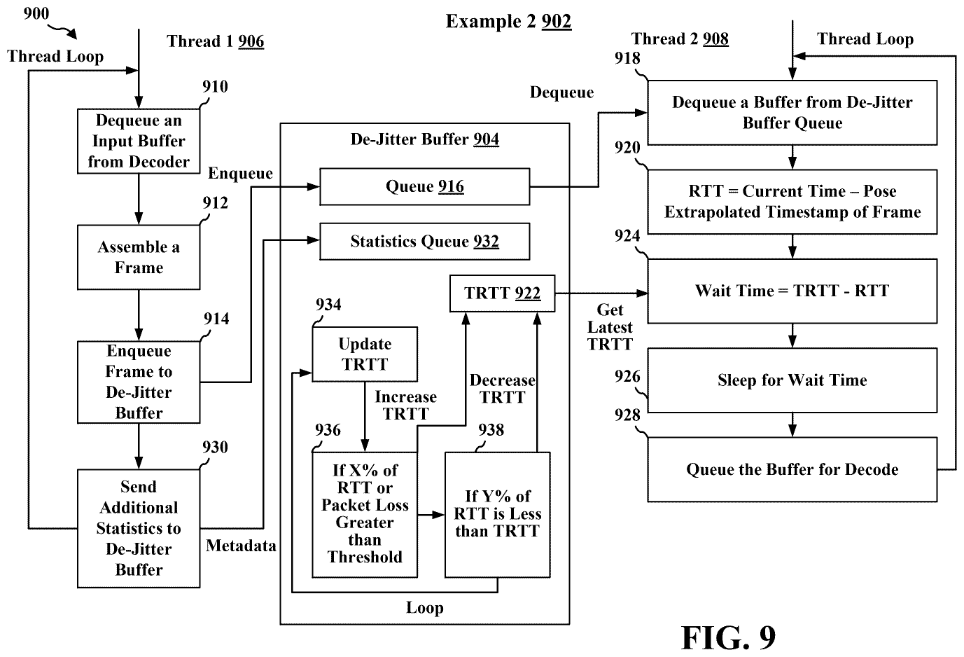

FIG. 9 is a diagram 900 illustrating a second example 902 of a de-jitter buffer 904 in a client HMD in accordance with one or more techniques of this disclosure. In an example, the de-jitter buffer 904 may be or include the de-jitter buffer 749. In an example, the de-jitter buffer 904 may be included in the device 104, the client HMD 406, the first HMD 506, the second HMD 512, or the client HMD 704. The de-jitter buffer 904 may be implemented in software. The de-jitter buffer 904 may be an adaptive length de-jitter buffer or an adaptive TRTT de-jitter buffer. With more particularity, in the second example 902, a TRTT for a frame may be computed at runtime. For instance, the de-jitter buffer 904 may utilize statistics (e.g., an RTT of a frame, a number of lost packets associated with the frame, etc.) to update the TRTT at runtime. In an example, the TRTT may increase in conditions of heavy channel interference and the TRTT may decrease in conditions of low channel interference (i.e., clean channel conditions). The de-jitter buffer 904 may help to ensure that frames incur a latency corresponding to the TRTT before a frame is input to a decoder.

The de-jitter buffer 904 may be associated with a first thread 906 (i.e., a first software thread) and a second thread 908 (i.e., a second software thread). The first thread 906 and the second thread 908 may operate concurrently. At 910, the first thread 906 may dequeue an input buffer from a decoder (e.g., the decoder 736). At 912, the first thread 906 may assemble a frame based on the input buffer. At 914, the first thread 906 may enqueue the assembled frame to a queue 916 included in or associated with the de-jitter buffer 904. The queue 916 may also be referred to as a de-jitter buffer queue.

At 930, the first thread 906 may obtain and send additional statistics to a statistics queue 932 included in and/or associated with the de-jitter buffer 904. The additional statistics may include an ARTT associated with frame(s) and/or an indication of a set of lost packets associated with the frame(s). For instance, the set of lost packets associated with the frame may be due to channel interference conditions. The additional statistics may be referred to as metadata. The first thread 906 may perform 910, 912, 914, and 930 in a loop (i.e., a thread loop). As depicted in the diagram 900 and as described above, the first thread 906 may push frames to the queue 916 as the frames are assembled and the first thread 906 may send the additional statistics to the de-jitter buffer 904 that may be used in adaptation logic (described below).

At 934, logic associated with the de-jitter buffer 904 may update a TRTT 922 based on the additional statistics in the statistics queue 932. In one example, at 936, if the logic determines that a number of packets in the set of lost packets is greater than X % (X is a number between zero and one-hundred), the logic may increase the TRTT. In another example, at 936, if the logic determines that the RTT (i.e., an ARTT) is greater than or equal to a threshold, the logic may increase the TRTT. In another example, at 938, if the logic determines that a number of packets in the set of lost packets is less than Y % (Y is a number between zero and one-hundred), the logic may decrease the TRTT. In another example, at 936, if the logic determines that the RTT (i.e., an ARTT) is less than a threshold, the logic may decrease the TRTT. In an example, 934, 936, and 938 may be performed in a loop.

At 918, the second thread 908 may dequeue a buffer from the queue 916. At 920, the second thread 908 may calculate an RTT. In an example, the second thread 908 may calculate the RTT according to equation (I) above. In another example, the second thread 908 may calculate the RTT as a difference between a current time and a pose extrapolated timestamp of a frame. The pose extrapolated timestamp of the frame may be a time at which pose coefficients were generated by a client HMD or a time at which a pose was extrapolated from the pose coefficients.

The second thread 908 may obtain the TRTT 922 that is included in or associated with the de-jitter buffer 904. The TRTT 922 may be the TRTT 753. In an example, the TRTT 922 may be a TRTT that was updated at 934 (e.g., via being increased at 936 or via being decreased at 938). The TRTT 922 may control an amount of jitter reduced for an RTT. The de-jitter buffer 904 may help to ensure that frames incur a latency corresponding to the TRTT 922 before a frame is input to a decoder. At 924, the second thread 908 may calculate a wait time according to equation (II) above, that is, the wait time may be a difference between the TRTT 922 and the RTT calculated at 920. At 926, the second thread 908 may sleep for the wait time. At 928, the second thread 908 may queue the buffer (that was dequeued from the queue 916) for decoding. In the event that the wait time computed at 924 is zero or negative, the second thread 908 may skip sleeping at 926 (i.e., the second thread 908 may sleep for zero seconds). The second thread 908 may perform 918, 920, 924, 926, and 928 in a loop (i.e., a thread loop). As depicted in the diagram 900 and as described above, the second thread 908 may pop frames from the queue 916 and calculate a wait time for a frame using a (latest) TRTT. After sleeping for the wait time (e.g., several milliseconds), the second thread 908 may input a frame to a decoder.

The above-described technologies may be associated with various advantages. The TRTT-based de-jitter buffer (e.g., the de-jitter buffer 749, the de-jitter buffer 804, the de-jitter buffer 904, etc.), as described herein, may enable a frame to come back to the same clock and may facilitate each frame incurring a fixed round-trip latency before each frame is input to a decoder. The TRTT-based de-jitter buffer may be a latency-based de-jitter buffer. In contrast, some de-jitter buffers may buffer up to N frames (N is a positive integer) and may cause the N frames to be played at a fixed cadence. An adaptation of a de-jitter buffer length may also be based on the latency (e.g., the round-trip time for a frame). As RTT latency increases, the length of the de-jitter buffer (analogous to TRTT) may also increase, and vice versa. An advantage of a TRTT-based de-jitter buffer may be that the “input rate to the jitter buffer” is equal to the “output rate from the jitter buffer” instantaneously. In contrast, some de-jitter buffers may be used in cases where the source frame rate is known (e.g., stored video streaming), but in an XR split rendering use case, a streaming rate may change depending on a complexity of the content over time. Some de-jitter buffers may utilize another algorithm to (1) determine that the input rate has changed and (2) accordingly adjust the output rate. With a TRTT-based de-jitter buffer, lower packet error rates may be achieved, as latency may be increased up to a point where all packets of a frame are received (or are waited for).

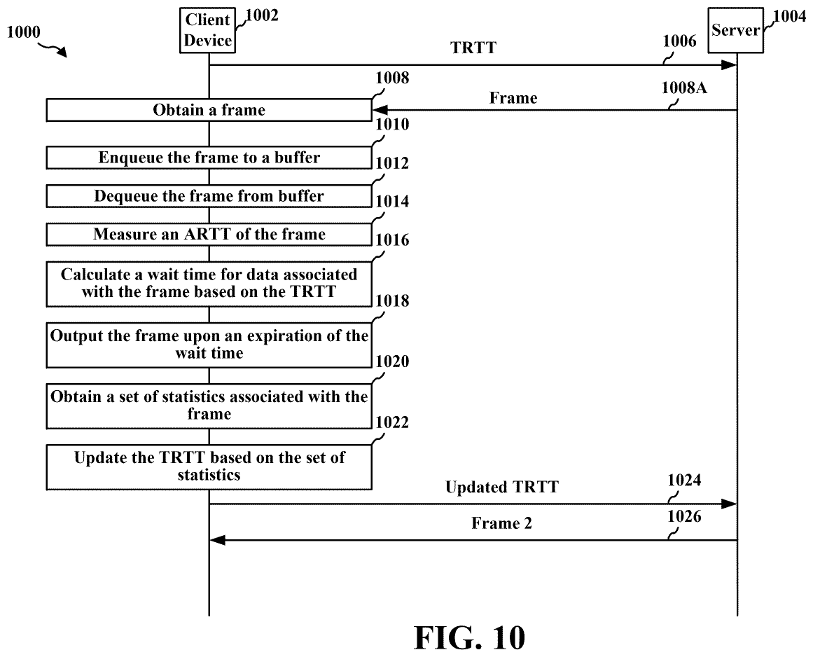

FIG. 10 is a call flow diagram 1000 illustrating example communications between a client device 1002 and a server 1004 in accordance with one or more techniques of this disclosure. In an example, the client device 1002 may be the device 104, the client HMD 406, the first HMD 506, the second HMD 512, or the client HMD 704. In an example, the server 1004 may be the device 104, the server 404, the first server 504, the second server 510, or the server 702.

At 1008, the client device 1002 may obtain a frame that is associated with a split rendering process between a server and a client device. For instance, at 1008A, the client device 1002 may receive the frame from the server 1004. At 1016, the client device 1002 may calculate a wait time for data associated with the frame based on a target round-trip time (TRTT) of the frame, where the TRTT may be a target time the data associated with the frame takes to travel between the client device 1002 and the server 1004 and back to the client device 1002. In one aspect, at 1014, the client device 1002 may measure an actual round trip time (ARTT) of the frame, where the ARTT may be an actual time the data associated with the frame takes to travel between the client device 1002 and the server and back to the client device 1002, and where calculating the wait time for the frame at 1016 may include calculating the wait time based on the measured ARTT. At 1018, the client device 1002 may output the frame upon an expiration of the wait time.

In one aspect, at 1010, the client device 1002 may enqueue the frame to a buffer after the obtainment of the frame at 1008. At 1012, the client device 1002 may dequeue, based on the TRTT, the frame from the buffer.

In one aspect, at 1006, the client device 1002 may transmit, for the server 1004, an indication of the TRTT, where obtaining the frame at 1008 may include obtaining the frame at an encoding bitrate, where the encoding bitrate may be based on the TRTT. An encoding bitrate may refer to a number of bits associated with a frame that are transmitted per second. Higher encoding bitrates may correspond to higher quality images and lower encoding bitrates may correspond to lower quality images. In one aspect, at 1020, the client device 1002 may obtain a set of statistics associated with the frame. At 1022, the client device 1002 may update the TRTT based on the set of statistics, where calculating the wait time for the data associated with the frame may include calculating the wait time for the data associated with the frame based on the updated TRTT and the ARTT. In an example, at 1024, the client device 1002 may transmit an indication of the updated TRTT to the server 1004. At 1026, the client device 1002 may receive a second frame from the server, where the second frame be received at an encoding bitrate that is based on the updated TRTT.

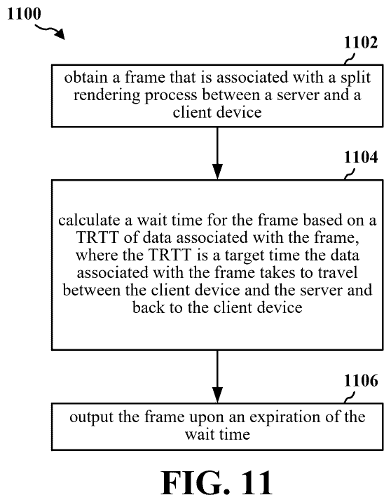

FIG. 11 is a flowchart 1100 of an example method of display processing in accordance with one or more techniques of this disclosure. The method may be performed by an apparatus, such as an apparatus for display processing, a CPU, a display processing unit (DPU) or other display processor, the device 104, DPU driver software executed by a CPU, the client HMD 406, the first HMD 506, the second HMD 512, the client HMD 704, the client device 1002, a wireless communication device, and the like, as used in connection with the aspects of FIGS. 1-10. The method may be associated with various advantages, such as reducing or eliminating jitter associated with frames displayed at a client device. In an example, the method may be performed by the jitter remover 198.

At 1102, the apparatus (e.g., a client device) obtains a frame that is associated with a split rendering process between a server and a client device. For example, FIG. 10 at 1008 shows that the client device 1002 may obtain a frame that is associated with a split rendering process between a server 1004 and the client device 1002. In an example, the split rendering process may correspond to/be associated with the split XR system 402. In an example, the server may be the device 104, the server 404, the first server 504, the second server 510, or the server 702. In an example, the frame may correspond to the frame 744. In an example, 1102 may be performed by the jitter remover 198.

At 1104, the apparatus (e.g., a client device) calculates a wait time for data associated with the frame based on a target round-trip time (TRTT) of the frame, where the TRTT is a target time the data associated with the frame takes to travel between the client device and the server and back to the client device. For example, FIG. 10 at 1016 shows that the client device 1002 may calculate a wait time for data associated with the frame based on a target round-trip time (TRTT) of the frame, where the TRTT is a target time the frame takes to travel between the client device 1002 and the server 1004 and back to the client device 1002. In an example, the wait time may be the de-jitter buffer wait time 751. In an example, the TRTT of the frame may be the TRTT 753, the TRTT 822, or the TRTT 922. In an example, the wait time may be calculated according to equation (II) above. In an example, calculating the wait time may correspond to 824 in FIG. 8. In an example, calculating the wait time may correspond to 924 in FIG. 9. In an example, 1104 may be performed by the jitter remover 198.

At 1106, the apparatus (e.g., a client device) outputs the frame upon an expiration of the wait time. For example, FIG. 10 at 1018 shows that the client device 1002 may output the frame upon an expiration of the wait time. In an example, outputting the frame upon the expiration of the wait time may correspond to 826 and 828 in FIG. 8. In an example, outputting the frame upon the expiration of the wait time may correspond to 926 and 928 in FIG. 9. In an example, 1106 may be performed by the jitter remover 198.

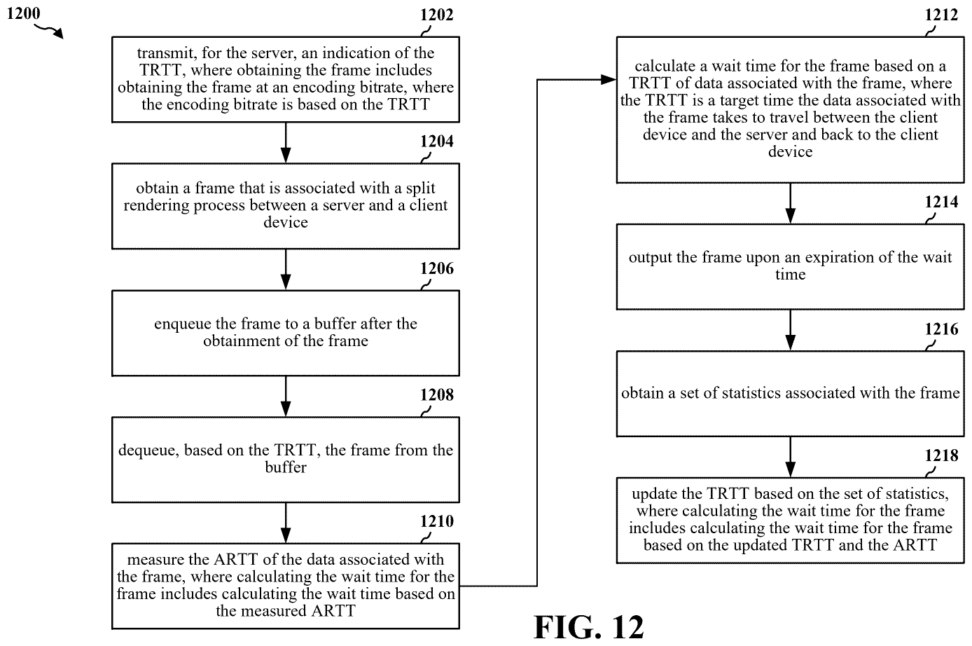

FIG. 12 is a flowchart 1200 of an example method of display processing in accordance with one or more techniques of this disclosure. The method may be performed by an apparatus, such as an apparatus for display processing, a CPU, a display processing unit (DPU) or other display processor, the device 104, DPU driver software executed by a CPU, the client HMD 406, the first HMD 506, the second HMD 512, the client HMD 704, the client device 1002, a wireless communication device, and the like, as used in connection with the aspects of FIGS. 1-10. The method may be associated with various advantages, such as reducing or eliminating jitter associated with frames displayed at a client device. In an example, the method (including the various aspects detailed below) may be performed by the jitter remover 198.

At 1204, the apparatus (e.g., a client device) obtains a frame that is associated with a split rendering process between a server and a client device. For example, FIG. 10 at 1008 shows that the client device 1002 may obtain a frame that is associated with a split rendering process between a server 1004 and the client device 1002. In an example, the split rendering process may correspond to/be associated with the split XR system 402. In an example, the server may be the device 104, the server 404, the first server 504, the second server 510, or the server 702. In an example, the frame may correspond to the frame 744. In an example, 1204 may be performed by the jitter remover 198.

At 1212, the apparatus (e.g., a client device) calculates a wait time for data associated with the frame based on a target round-trip time (TRTT) of the frame, where the TRTT is a target time the data associated with the frame takes to travel between the client device and the server and back to the client device. For example, FIG. 10 at 1016 shows that the client device 1002 may calculate a wait time for data associated with the frame based on a target round-trip time (TRTT) of the frame, where the TRTT is a target time the frame takes to travel between the client device 1002 and the server 1004 and back to the client device 1002. In an example, the wait time may be the de-jitter buffer wait time 751. In an example, the TRTT of the frame may be the TRTT 753, the TRTT 822, or the TRTT 922. In an example, the wait time may be calculated according to equation (II) above. In an example, calculating the wait time may correspond to 824 in FIG. 8. In an example, calculating the wait time may correspond to 924 in FIG. 9 . . . . In an example, 1212 may be performed by the jitter remover 198.

At 1214, the apparatus (e.g., a client device) outputs the frame upon an expiration of the wait time. For example, FIG. 10 at 1018 shows that the client device 1002 may output the frame upon an expiration of the wait time. In an example, outputting the frame upon the expiration of the wait time may correspond to 826 and 828 in FIG. 8. In an example, outputting the frame upon the expiration of the wait time may correspond to 926 and 928 in FIG. 9. In an example, 1214 may be performed by the jitter remover 198.

In one aspect, at 1206, the apparatus (e.g., a client device) may enqueue the frame to a buffer after the obtainment of the frame. For example, FIG. 10 at 1010 shows that the client device 1002 may enqueue the frame to a buffer after the obtainment of the frame. For example, the buffer may be or include the de-jitter buffer 804 or the de-jitter buffer 904. In another example, FIG. 8 shows that the first thread 806 may enqueue a frame to the queue 816 of the de-jitter buffer 804. In a further example, FIG. 9 shows that the first thread 906 may enqueue a frame to the queue 916 of the de-jitter buffer 904. In another example, the buffer may be the de-jitter buffer 749. In an example, 1206 may be performed by the jitter remover 198.

In one aspect, at 1208, the apparatus (e.g., a client device) may dequeue, based on the TRTT, the frame from the buffer. For example, FIG. 10 at 1012 shows that the client device 1002 may dequeue, based on the TRTT, the frame from the buffer. In another example, the aforementioned aspect may correspond to 818 in FIG. 8. In another aspect, the aforementioned aspect may correspond to 918 in FIG. 9. In an example, 1208 may be performed by the jitter remover 198.

In one aspect, enqueuing the frame to the buffer may include enqueuing a bitstream representation of the frame to the buffer, and dequeuing the frame may include dequeuing the bitstream representation of the frame from the buffer based on the TRTT. For example, enqueuing the frame to the buffer at 1010 may include enqueuing a bitstream representation of the frame to the buffer, and dequeuing the frame at 1012 may include dequeuing the bitstream representation of the frame from the buffer based on the TRTT.

In one aspect, the buffer may be a de-jitter buffer. For example, the data associated with the frame may include at least one of the frame or pose data associated with the client device 1002.

In one aspect, an enqueue rate of the buffer may be equal to a dequeue rate of the buffer. For example, an enqueue rate of the queue 816 of the de-jitter buffer 804 may be equal to a dequeue rate of the queue 816 of the de-jitter buffer 804. In another example, an enqueue rate of the queue 916 of the de-jitter buffer 904 may be equal to a dequeue rate of the queue 916 of the de-jitter buffer 904. In enqueue rate may refer to a rate at which frames are placed into a buffer. A dequeue rate may refer to a rate at which frames are removed from the buffer.

In one aspect, the frame may be an encoded frame, and outputting the frame upon the expiration of the wait time may include decoding the frame upon the expiration of the wait time. For example, FIG. 8 at 828 shows that the frame may be an encoded frame and that the second thread 808 may decode the frame upon the expiration of the wait time. In another example, FIG. 9 at 928 shows that the frame may be an encoded frame and that the second thread 908 may decode the frame upon the expiration of the wait time. In another example, FIG. 7 shows that the decoder 736 may decode a frame upon an expiration of the de-jitter buffer wait time 751.

In one aspect, outputting the frame upon the expiration of the wait time may further include transmitting the decoded frame for display on a display panel. For example, the display panel may be the display 746. In another example, the display panel may be or include the display(s) 131.

In one aspect, the frame may be an encoded frame, and outputting the frame upon the expiration of the wait time may include decoding the frame. For example, outputting the frame upon the expiration of the wait time at 1018 may include decoding the frame. In another example, FIG. 7 shows that the decoder 736 may decode a frame upon an expiration of a wait time.

In one aspect, the frame may be an encoded frame, and outputting the frame upon the expiration of the wait time may further include storing the decoded frame in a buffer. For example, outputting the frame upon the expiration of the wait time at 1018 may include storing the decoded frame in a buffer.

In one aspect, the frame may be an encoded frame, and outputting the frame upon the expiration of the wait time may further include releasing the decoded frame from the buffer upon the expiration of the wait time. For example, outputting the frame upon the expiration of the wait time at 1018 may include releasing the decoded frame from the buffer upon the expiration of the wait time.

In one aspect, calculating the wait time for the frame may include calculating the wait time for the frame further based on an actual round trip time (ARTT) of the data associated with the frame, where the ARTT may be an actual time the data associated with the frame takes to travel between the client device and the server and back to the client device.

In one aspect, at 1210, the apparatus (e.g., a client device) may measure the ARTT of the frame, and calculating the wait time for the frame may include calculating the wait time based on the measured ARTT. For example, FIG. 10 at 1014 shows that the client device 1002 may measure the ARTT of the frame, and calculating the wait time for the frame at 1016 may include calculating the wait time based on the measured ARTT. In an example, the ARTT of the frame may be the RTT 747. In another example, measuring the ARTT may include aspects described above with respect to equation (I). In an example, 1210 may be performed by the jitter remover 198.

In one aspect, measuring the ARTT of the frame may include: obtaining a first indication of a first time instance at which a pose extrapolation for the frame was performed. For example, the first indication of the first time instance may correspond to “Pose Extrapolated Timestamp” in equation (I) above.

In one aspect, measuring the ARTT of the frame may include: obtaining a second indication of a second time instance at which the frame was assembled. For example, the second indication of the second time instance may correspond to “Assemble End Time” in equation (I) above.

In one aspect, measuring the ARTT of the frame may include: measuring the ARTT based on the first indication and the second indication. For example, measuring the ARTT based on the first indication and the second indication may correspond to equation (I) above.

In one aspect, the TRTT may be a preconfigured TRTT. For example, the TRTT may be the TRTT 753 or the TRTT 822.

In one aspect, at 1216, the apparatus (e.g., a client device) may obtain a set of statistics associated with the frame. For example, FIG. 10 at 1020 shows that the client device 1002 may obtain a set of statistics associated with the frame. In an example, the set of statistics associated with the frame may correspond to 930 in FIG. 9. In an example, 1216 may be performed by the jitter remover 198.

In one aspect, at 1218, the apparatus (e.g., a client device) may update the TRTT based on the set of statistics, where calculating the wait time for the frame may include calculating the wait time for the frame based on the updated TRTT and the ARTT. For example, FIG. 10 at 1022 shows that the client device 1002 may update the TRTT based on the set of statistics, where calculating the wait time for the frame may include calculating the wait time for the frame based on the updated TRTT and the ARTT. In another example, updating the TRTT may correspond to 934 in FIG. 9. In an example, 1218 may be performed by the jitter remover 198.

In one aspect, the set of statistics may include at least one of: the ARTT of the frame, or an indication of a set of lost packets associated with the frame. A set of lost packets associated with the frame may refer to packets associated with the frame that are transmitted by a server, but that are not received by a client device (e.g., due to channel interference). For example, the additional statistics sent at 930 in FIG. 9 may include at least one of: the ARTT of the frame, or an indication of a set of lost packets associated with the frame.

In one aspect, updating the TRTT based on the set of statistics may include: comparing the ARTT to a threshold. For example, the aforementioned aspect may correspond to 936 in FIG. 9.

In one aspect, updating the TRTT based on the set of statistics may include: changing the TRTT based on the comparison. For example, the aforementioned aspect may correspond to 934 and 936 in FIG. 9.

In one aspect, updating the TRTT based on the set of statistics may include: comparing a number of lost packets in the set of lost packets to a threshold. For example, the aforementioned aspect may correspond to 936 in FIG. 9.

In one aspect, updating the TRTT based on the set of statistics may include: changing the TRTT based on the comparison. For example, the aforementioned aspect may correspond to 934 and 936 in FIG. 9.

In one aspect, the frame may include extended reality (XR) content, and the client device may include an XR device. In another example, the frame may be associated with the split XR system 402. In an example, the client device 1002 may be an XR device.

In one aspect, at 1202, the apparatus (e.g., a client device) may transmit, for the server, an indication of the TRTT, where obtaining the frame may include obtaining the frame at an encoding bitrate, where the encoding bitrate may be based on the TRTT. For example, FIG. 10 at 1006 shows that the client device 1002 may transmit, for the server 1004, an indication of the TRTT, where obtaining the frame at 1008 may include obtaining the frame at an encoding bitrate, where the encoding bitrate may be based on the TRTT. In an example, 1202 may be performed by the jitter remover 198.

In one aspect, the TRTT may be greater than a prior TRTT, and the encoding bitrate may be less than a prior encoding bitrate. For example, the encoding bit rate associated with the frame obtained at 1008 may be less than a prior encoding bitrate of the prior TRTT.

In one aspect, the TRTT may be less than a prior TRTT, and the encoding bitrate may be greater than a prior encoding bitrate. For example, the encoding bit rate associated with the frame obtained at 1008 may be greater than a prior encoding bitrate of the prior TRTT.

In configurations, a method or an apparatus for display processing is provided. The apparatus may be a DPU, a display processor, or some other processor that may perform display processing. In aspects, the apparatus may be the display processor 127 within the device 104, or may be some other hardware within the device 104 or another device. The apparatus may include means for obtaining a frame that is associated with a split rendering process between a server and a client device. The apparatus may further include means for calculating a wait time for data associated with the frame based on a target round-trip time (TRTT) of the frame, where the TRTT is a target time the data associated with the frame takes to travel between the client device and the server and back to the client device. The apparatus may further include means for outputting the frame upon an expiration of the wait time. The apparatus may further include means for enqueuing the frame to a buffer after the obtainment of the frame. The apparatus may further include means for dequeuing, based on the TRTT, the frame from the buffer. The apparatus may further include means for measuring the ARTT of the frame, where calculating the wait time for the frame includes calculating the wait time based on the measured ARTT. The apparatus may further include means for transmitting, for the server, an indication of the TRTT, where obtaining the frame includes obtaining the frame at an encoding bitrate, where the encoding bitrate is based on the TRTT. The apparatus may further include means for obtaining a set of statistics associated with the frame. The apparatus may further include means for updating the TRTT based on the set of statistics, where calculating the wait time for the frame includes calculating the wait time for the frame based on the updated TRTT and the ARTT.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of display processing, including: obtaining a frame that is associated with a split rendering process between a server and a client device; calculating a wait time for the frame based on a target round-trip time (TRTT) of the data associated with the frame, wherein the TRTT is a target time the data associated with the frame takes to travel between the client device and the server and back to the client device; and outputting the frame upon an expiration of the wait time.

Aspect 2 may be combined with aspect 1, further including: enqueuing the frame to a buffer after the obtainment of the frame; and dequeuing, based on the TRTT, the frame from the buffer.

Aspect 3 may be combined with aspect 2, wherein enqueuing the frame to the buffer includes enqueuing a bitstream representation of the frame to the buffer, and wherein dequeuing the frame includes dequeuing the bitstream representation of the frame from the buffer based on the TRTT.

Aspect 4 may be combined with any of aspects 2-3, wherein the data associated with the frame includes at least one of the frame or pose data associated with the client device.

Aspect 5 may be combined with any of aspects 2-4, wherein an enqueue rate of the buffer is equal to a dequeue rate of the buffer.

Aspect 6 may be combined with any of aspects 1-5, wherein the frame is an encoded frame, and wherein outputting the frame upon the expiration of the wait time includes decoding the frame upon the expiration of the wait time.

Aspect 7 may be combined with aspect 6, wherein outputting the frame upon the expiration of the wait time further includes transmitting the decoded frame for display on a display panel.

Aspect 8 may be combined with any of aspects 1-7, wherein the frame is an encoded frame, and wherein outputting the frame upon the expiration of the wait time comprises: decoding the frame; storing the decoded frame in a buffer; and releasing the decoded frame from the buffer upon the expiration of the wait time.

Aspect 9 may be combined with any of aspects 1-8, wherein calculating the wait time for the frame further comprises calculating the wait time for the frame based on an actual round trip time (ARTT) of the data associated with the frame, and wherein the ARTT is an actual time the data associated with the frame takes to travel between the client device and the server and back to the client device.

Aspect 10 may be combined with aspect 9, further including: measuring the ARTT of the frame, wherein calculating the wait time for the frame includes calculating the wait time based on the measured ARTT.

Aspect 11 may be combined with aspect 10, wherein measuring the ARTT of the frame includes: obtaining a first indication of a first time instance at which a pose extrapolation for the frame was performed; obtaining a second indication of a second time instance at which the frame was assembled; and measuring the ARTT based on the first indication and the second indication.

Aspect 12 may be combined with any of aspects 9-11, further including: obtaining a set of statistics associated with the frame; and updating the TRTT based on the set of statistics, wherein calculating the wait time for the frame comprises calculating the wait time for the frame based on the updated TRTT and the ARTT.

Aspect 13 may be combined with aspect 12, wherein the set of statistics includes at least one of: the ARTT of the frame, or an indication of a set of lost packets associated with the frame.

Aspect 14 may be combined with aspect 13, wherein updating the TRTT based on the set of statistics includes: comparing the ARTT to a threshold; and changing the TRTT based on the comparison.

Aspect 15 may be combined with any of aspects 13-14, wherein updating the TRTT based on the set of statistics includes: comparing a number of lost packets in the set of lost packets to a threshold; and changing the TRTT based on the comparison.

Aspect 16 may be combined with any of aspects 1-15, wherein the frame includes extended reality (XR) content, and wherein the client device includes an XR device.

Aspect 17 may be combined with any of aspects 1-16, further including: transmitting, for the server, an indication of the TRTT, wherein obtaining the frame includes obtaining the frame at an encoding bitrate, wherein the encoding bitrate is based on the TRTT.

Aspect 18 may be combined with aspect 17, wherein the TRTT is greater than a prior TRTT, and wherein the encoding bitrate is less than a prior encoding bitrate.

Aspect 19 may be combined with aspect 17, wherein the TRTT is less than a prior TRTT, and wherein the encoding bitrate is greater than a prior encoding bitrate.

Aspect 20 may be combined with any of aspects 1-19, wherein the TRTT is a preconfigured TRTT.

Aspect 21 is an apparatus for display processing comprising a processor coupled to a memory and, based on information stored in the memory, the processor is configured to implement a method as in any of aspects 1-20.

Aspect 22 may be combined with aspect 21 and comprises that the apparatus is a wireless communication device comprising at least one of a transceiver or an antenna coupled to the processor, and wherein to obtain the frame, the processor is configured to obtain the frame via at least one of the transceiver or the antenna.

Aspect 23 is an apparatus for display processing comprising means for implementing a method as in any of aspects 1-20.

Aspect 24 is a computer-readable medium (e.g., a non-transitory computer readable-medium) storing computer executable code, the computer executable code, when executed by a processor, causes the processor to implement a method as in any of aspects 1-20.

Various aspects have been described herein. These and other aspects are within the scope of the following claims.

1. An apparatus for display processing, comprising:
a memory; and
a processor coupled to the memory and, based on information stored in the memory, the processor is configured to:
obtain a frame that is associated with a split rendering process between a server and a client device;
calculate a wait time for the frame based on a target round-trip time (TRTT) of data associated with the frame, wherein the TRTT is a target time the data associated with the frame takes to travel between the client device and the server and back to the client device; and
output the frame upon an expiration of the wait time.

2. The apparatus of claim 1, wherein the processor is further configured to:
enqueue the frame to a buffer after the obtainment of the frame; and dequeue, based on the TRTT, the frame from the buffer.

3. The apparatus of claim 2, wherein to enqueue the frame to the buffer, the processor is configured to enqueue a bitstream representation of the frame to the buffer, and wherein to dequeue the frame, the processor is configured to dequeue the bitstream representation of the frame from the buffer based on the TRTT.

4. The apparatus of claim 2, wherein the data associated with the frame includes at least one of the frame or pose data associated with the client device.

5. The apparatus of claim 2, wherein an enqueue rate of the buffer is equal to a dequeue rate of the buffer.

6. The apparatus of claim 1, wherein the frame is an encoded frame, and wherein to output the frame upon the expiration of the wait time, the processor is configured to decode the frame upon the expiration of the wait time.

7. The apparatus of claim 6, wherein to output the frame upon the expiration of the wait time, the processor is configured to transmit the decoded frame for display on a display panel.

8. The apparatus of claim 1, wherein the frame is an encoded frame, and wherein to output the frame upon the expiration of the wait time, the processor is configured to:
decode the frame;
store the decoded frame in a buffer; and
release the decoded frame from the buffer upon the expiration of the wait time.

9. The apparatus of claim 1, wherein to calculate the wait time for the frame, the processor is further configured to calculate the wait time for the frame based on an actual round trip time (ARTT) of the data associated with the frame, and wherein the ARTT is an actual time the data associated with the frame takes to travel between the client device and the server and back to the client device.

10. The apparatus of claim 9, wherein the processor is further configured to:
measure the ARTT of the frame, wherein to calculate the wait time for the frame, the processor is configured to calculate the wait time based on the measured ARTT.

11. The apparatus of claim 10, wherein to measure the ARTT of the frame, the processor is configured to:
obtain a first indication of a first time instance at which a pose extrapolation for the frame was performed;
obtain a second indication of a second time instance at which the frame was assembled; and
measure the ARTT based on the first indication and the second indication.

12. The apparatus of claim 9, wherein the processor is further configured to:
obtain a set of statistics associated with the frame; and
update the TRTT based on the set of statistics, wherein to calculate the wait time for the frame, the processor is configured to calculate the wait time for the frame based on the updated TRTT and the ARTT.

13. The apparatus of claim 12, wherein the set of statistics comprises at least one of:
the ARTT of the frame, or
an indication of a set of lost packets associated with the frame.

14. The apparatus of claim 13, wherein to update the TRTT based on the set of statistics, the processor is configured to:
compare the ARTT to a threshold; and
change the TRTT based on the comparison.

15. The apparatus of claim 13, wherein to update the TRTT based on the set of statistics, the processor is configured to:
compare a number of lost packets in the set of lost packets to a threshold; and
change the TRTT based on the comparison.

16. (canceled)

17. The apparatus of claim 1, wherein the processor is further configured to:
transmit, for the server, an indication of the TRTT, wherein to obtain the frame, the processor is configured to obtain the frame at an encoding bitrate, wherein the encoding bitrate is based on the TRTT.

18. The apparatus of claim 17, wherein the TRTT is greater than a prior TRTT, and wherein the encoding bitrate is less than a prior encoding bitrate.

19. The apparatus of claim 17, wherein the TRTT is less than a prior TRTT, and wherein the encoding bitrate is greater than a prior encoding bitrate.

20. The apparatus of claim 1, wherein the TRTT is a preconfigured TRTT.

21. (canceled)

22. A method of display processing, comprising:
obtaining a frame that is associated with a split rendering process between a server and a client device;
calculating a wait time for the frame based on a target round-trip time (TRTT) of data associated with the frame, wherein the TRTT is a target time the data associated with the frame takes to travel between the client device and the server and back to the client device; and
outputting the frame upon an expiration of the wait time.

23.-30. (canceled)
